(19) United States
(12) Patent Application Publication
(10) Pub. No.: US 2006/0210138 A1
(43) Pub. Date: Sep. 21, 2006

(54) Verification of authenticity of check data

(76) Inventors: David Hilton, Glos (GB); Peter Wells, Berkshire (GB); Weichao Tan, Oxford (GB)

Correspondence Address: Richard C Woodbridge;Synnestvedt Lechner & Woodbridge, P O Box 592, Princeton, NJ, 08542-0592, US

(21) Appl. No.: 10/552,536

(22) PCT Filed: Mar. 31, 2004
(86) PCT No.: PCT/GB04/01397

§ 371 Date: Oct. 11, 2005

(30) Foreign Application Priority Data
Apr. 11, 2003 (GB) 0308413.4

(51) Int. Cl. G06K 9/00

(52) U.S. Cl. 382/137

(57) ABSTRACT

The invention recognises that both human readable data printed on a check and machine readable data added to the check at the time of check printing to graphically encode the human readable data are subject to errors and artefacts during the initial printing and subsequent scanning processes: if, after scanning, there is a less than perfect match in the two forms of data, that does not therefore necessarily imply fraudulent alteration of the human readable data. The present invention enables a quantitative, probability-based interpretation of the degree and the kind of mismatch to verify authenticity.

### BACKGROUND OF THE INVENTION

1. Field of the Invention

This invention concerns the automatic verification of the authenticity of data printed onto a check. High speed, low resolution optical scanners are the means of image acquisition prior to analysis. As with the prior art, the basis of the method is the comparison of human readable information with information that is solely machine readable (‘machine readable’ information, data, symbols etc.) added to the check at the time of printing. Someone fraudulently altering the check (e.g. to change the payee name) may be able to quite readily alter the human readable printed information, but should find it far harder to alter the machine readable data to match the fraudulently altered human readable data if the way that the machine readable data encodes information is secret and secure. Although ‘human readable’ information is also machine readable using conventional OCR, we use the term ‘machine readable’ to refer to information that is not readily and ordinarily human readable.

2. Description of the Prior Art

There is a need to provide a cheap and rapid means of corroborating the authenticity of the critical, human readable data on checks in order to identify fraudulent falsification. Checks are the subject of high speed printing and scanning operations: operational constraints generally require anti-fraud techniques to integrate with existing schemes. Thus, a number of methods have been proposed in which human readable data, plus additional machine readable symbols or data that encode the same data as the human readable data, are printed onto checks. Both kinds of data are subsequently scanned and analysed by image sorters.

Verification of checks by adding machine readable symbols has a long history. A method of authenticating check data was provided by Szepenski (German Patent 29 43 436 A1) in 1979, although his description was not particularly concerned with the workflow issues associated with image sorters and the like. Text on documents in his method was to be authenticated by means of a machine readable pattern which contained the same information as the human readable text and extended over the whole document. The pattern was to contain all of the textual information and in a paper published more or less concurrently Szepenski suggested the use of standard error correction techniques to overcome the inevitable problems of accurate machine reading.

EP 0 699 327 B1 Abathorn describes a modified version of Szepenski's method in which the machine readable data is in the form of a bar code (or other symbology which is not specified) to be added to the check. This patent goes further by describing how the machine readable the data might be added “in a single pass through the printing system enabling high speed automated mass production of bearer documents.” There is little description of the coding method but the fact that “if a user's name has been obscured, the name can be recovered if the name was selected as a value critical data item” suggests that the machine readable data is not hashed or encrypted.

Ramzy, U.S. Pat. No. 6,073,121 also describes a method of protecting a check by adding machine readable data, in this case the data comprising “all the check data” in the form of a bar code or other symbol. Ramzy differs from Abathorn in that the added data is encrypted.

The implication is that the data retrieved from the bar code must be retrieved in its entirety or else it is not decipherable, and this implies that the bar code or other symbol must be robust against poor quality imaging.

In U.S. Pat. No. 6,243,480 Zhao et al authenticate check data by adding “authentication information” in machine readable form, this form either being a watermark or a symbol which could be a bar code. The authentication information described in the patent is some form of digest of semantic information. The digest formed from the OCR allows a certain amount of latitude in that commonly confused characters such as “c” and “e” are allowed to be in error without destroying the correspondence between the two versions of the authentication information. However, the machine readable code is such that corruption of it is not reversible and there is no possibility of relaxing the equality condition if, for instance, a bar code is damaged by a scanning problem. As is stated in the claims “an authentication information reader reads the first authentication information . . . ” and compares with data from “an authenticator that computes the second authentication information” “Reading” the information as opposed to computing information in general allows no scope for adjusting to poor quality images.

Similarly in U.S. Pat. No. 6,170,744 Payformance tackles the problem of self authentication by including authenticating data in machine readable form. The authenticating data as above includes some form of digest in the form of a hash, signature or encryption and in each case the data is not reversible or would not be reversible if some uncorrectable reading error occurred. The verification is by equality of two values and has no provision for close misses or data adjustment

In U.S. Pat. No. 6,233,340 Sandru describes yet another method of adding authenticating data and here again the data is concatenated in some way which prevents it being deciphered when damaged by the imaging process.

It is also well known that certain characters are easily confused by the OCR process, characters such as O and 0, C and O, F and E etc. Now in U.S. Pat. No. 6,243,480 Mediasec) these sorts of characters are allowed to be considered interchangeable to reduce the OCR reading errors, but no information about how much confusion has occurred will be available.

An important distinction in methods described in the prior art is between those that aggregate the characters in some manner and calculate a representative value and those that encode the characters individually. The implication is that where data has been aggregated any failure in the retrieval process may render the whole of the data invalid, whereas if the data is segregated, damage to parts of the data may leave the remaining data decipherable.

The two commonly used forms of data aggregation are encryption and hashing. In all standard encryption algorithms, e.g DES, RSA, Blowfish, it is regarded as important that each bit of the plaintext affects every other bit to produce the ciphertext, this requirement rendering the breaking of the code much more difficult. A consequence of this is that alteration of any portion of the cipher text has a potential effect on every bit of the plaintext. Thus if ciphertext is embedded in the machine readable code and any part of that code cannot be correctly retrieved the whole of the plaintext is invalid.

In the case of hashing, a similar situation holds. Hashing algorithms e.g MD5, SHA1 etc are designed so that hashed values which differ slightly correspond to originals that differ considerably. Again, if a hash value of the text is embedded in machine readable form, any minor error in the subsequent reading of the text data will produce a totally different hash value and no information will be given about the matching of items.

In those versions of the prior art which use encryption or hashing, any misread in either OCR or the machine readable data will result in mismatch of the values that are required for authentication. The only outcome of such a comparison is agreement or non agreement and the level of disagreement is identical whether one or all of the original data characters is misread by the OCR, or whether one or all of the bits of the version of the hash value after error correction is altered. The check printing and scanning environment is an especially demanding one since checks are printed in large volume at very high speeds; scanning also operates on very high volumes of checks with relatively low resolution. Hence, it is an especially challenging environment for an automated document authentication system.

Given that for the data on checks the probability of correct automated identification of all of the human readable characters is at best 98 to 99%, then a huge number of checks will be incorrectly identified as fraudulent using conventional hashing or encryption based techniques.

In most methods therefore, the machine readable encoded data is some representation of the totality of all of the data, so that damage to a part of the representation removes the possibility of any meaningful data retrieval; this greatly hampers the speed of the automatic verification of authenticity where fast, high volume printers are used to print the checks and fast, low resolution scanners are used to scan them since the authenticity of so many checks cannot be automatically verified. For large scale systems issuing several million checks a month, even a false rejection rate of 2% leads to huge numbers of checks that are needlessly rejected by an automated system and then have to be manually scrutinised for authenticity.

The problem with methods that have so far been proposed is that no proper account is taken of the degradation that may well occur to the added symbols during normal printing, as well as the inevitable misreading that is inherent in OCR of human readable data. Simply rejecting checks where the OCR of the human readable data does not identically match the retrieved machine readable data results in large numbers of satisfactory checks being sent for inspection, which is both costly and slow.

### SUMMARY OF THE PRESENT INVENTION

In a first aspect, the invention is a method of automatically verifying the authenticity of a printed document which includes printed human readable data and corresponding machine readable data, the method comprising the steps of:

(a) scanning the document to generate a scanned image;

(b) interpreting the individual characters printed as human readable data and interpreting the individual characters printed as machine readable data;

(c) assessing the probability that any mismatch between the individual characters interpreted from the human readable data and the machine readable data has arisen through errors or artefacts introduced in printing or scanning the document and not deliberate falsification of the human readable data.

The invention arises from the recognition that both human readable data printed on a check and machine readable data added to the check at the time of check printing to graphically encode the human readable data are subject to errors and artefacts during the initial printing and subsequent scanning processes: if, after scanning, there is a less than perfect match in the two forms of data, that does not therefore necessarily imply fraudulent alteration of the human readable data. The present invention enables a quantitative, probability-based interpretation of the degree and the kind of mismatch to verify authenticity.

The assessed probability of mismatch arising through printer or scanner error or artefact may be a function of the quality of the scanned image; image quality can be measured as a function of one or more of: the lightness or darkness of the image; the contrast of the image; whether features of known shape in the document appear in a similar shape in the scanned image; the degree of adjustment required to make mismatched characters match; mismatch from MICR data; orientation accuracy of the scanned image.

This is valuable because as image quality deteriorates, it is very useful to be able to automatically relax the matching requirements between the scanned and interpreted human readable text and the machine readable text, since mismatches are more likely to be due to errors or artefacts rather than fraudulent alteration. This relaxation of matching requirements can be done in several ways, such as altering a probability based interpretation of what the human readable data and/or machine readable data is (e.g. allowing a character that appears to be a ‘c’ also to be a ‘o’ and a ‘l’).

The assessed probability may be a function of the relative position or distribution of any mismatches such that clustered mismatches decrease the probability that the mismatches arise through printer or scanner error or artefact (except in cases of localised image degradation identifiable by irregularities of lines, i.e. the local image quality). The assessed probability may also be a function of the font used for the machine readable data.

The present invention also enables an operator to alter the probability based interpretations, and to alter the required degree of matching for the system to deem a check to be authenticated. This is very useful since the errors and artefacts introduced by printing and scanning can alter: for example, due to slight scanner lens mis-alignment, all scanned images produced by a particular scanner might on one particular day have a very high likelihood of leading to a ‘H’ being interpreted as a ‘N’; then, the operator can ‘tune’ the system to de-sensitise it to mismatches of H and N: hence, if the human readable data is interpreted as ‘NUGN’ but the machine readable data is interpreted as the name ‘HUGH’, the system will automatically know that the mismatch is not indicative of fraudulent alteration but is far more likely to be associated with scanner error.

A function representing the probability of falsification, rather than error or artefact, can be empirically derived by analysing extensive manual assessments made by skilled operators of different kinds of mismatches.

In an implementation, we map the probability of each member of an alphabet (e.g. letters A-Z, plus a given number range) corresponding to any feature that is identified as a character in the human readable data. Hence, a circular feature in the human readable data would have a high probability of being the letter ‘o’, but a low probability of being the letter ‘l’. Similarly, we map the probability of each member of the alphabet (e.g. A-Z, plus a given number range) corresponding to any feature that is identified as a character in the machine readable data. For example, a sequence of two vertical bars might have a high probability of being the letter ‘c’ and low probability of being the letter ‘t’. This probability mapping process is done in respect of large amounts of trial data from large numbers of sample checks, but using the same printing and scanning equipment that would be used in practice to print and to scan real checks at high volume and high speed. Once the probability mapping is complete, then verification of the authenticity of a real check involves in essence-scanning that cheque to establish if there is a perfect match between the scanned and interpreted human readable data and the scanned, interpreted machine readable data. If there is no perfect match, then, instead of rejecting the check, the automated verification process of the present invention can continue by measuring or obtaining (i) a probabilistic interpretation of the scanned, human readable data and also (ii) a probabilistic interpretation of the scanned, machine readable data. We then compare the two interpretations to determine if the correspondence satisfies a pre-defined threshold. The comparison can take as a base the most likely interpretation of the machine readable data; using this interpretation, we take the first character and compare it to each of the different possible characters occupying the position of first character in the human readable data. Hence, the machine readable data might begin with character ‘H’. The first character in the human readable text might be an ‘H’ and also a ‘N’ at the same level of probability, and a ‘M’ at a lower level of probability. There is an identical match (‘H’ in the machine readable and ‘H’ in the human readable and a correlation score is kept. This process continues for all characters and the cumulative correlation score is then compared to a threshold; if above a threshold, the check is passed and if below, the check is sent for further examination. Equally, the process can work using each of the most likely characters from the human readable data as a base and correlating each of these to the possible interpretations of each machine readable character.

If the correlation satisfies the pre-defined threshold, then we accept that the machine readable data is sufficiently close to the human readable data for the check to be regarded as authentic. We have in effect subtracted out the effect of predefined printing and scanning errors and artefacts so that these do not lead to erroneous ‘false positives’—i.e. incorrect indications that a cheque is inauthentic when it in fact is authentic. If the correspondence does not satisfy the pre-defined threshold, then the check is submitted to more detailed scrutiny.

In the context of high speed check printing and scanning, being able to model and subtract out the effects of normal printing and scanning errors and artefacts enables a very significant reduction in false positives-checks that have to be submitted for further scrutiny but turn out to be authentic.

In more general terms, the form of coding for the machine readable data is made to depend upon the characteristics of the human readable text and its retrievability and comprises independent segments that allow for partial recovery despite localised degradation. The analyses of the human readable text and machine readable code are mutually dependent and, together with external data, provide a probability model for the detection of possible fraudulent checks.

The comparison of the probability based interpretations can use a metric specifically tailored to one or more of: printer performance; scanner performance; image quality; operator assigned rules. Similarly, the first probability based interpretation and the second probability based interpretation themselves can use a metric specifically tailored to one or more of: printer performance; scanner performance; image quality; operator assigned rules.

Also, the threshold can be varied by an operator depending on one or more of printer performance; scanner performance; image quality; operator assigned rules.

As described above, the present invention requires the comparison of data printed in at least two different forms on a document, such as a check. The two different forms may be a human readable form and a machine readable form. The documents are scanned at the time of authentication and the images are analysed to allow a probabilistic comparison to be made. Each form of data appearing on the document will require its own algorithm to retrieve the encoded data. This algorithm may be a form of OCR, or a bar code interpreter, or a customised interpreter for special forms of encoding such as the ‘Seal encoding’ which is part of one implementation of the present invention; ‘Seal’ encoding is described in more detail in PCT/GB02/00539, which is incorporated by reference herein.

The data that is added usually originates in the form of a string of alphanumeric characters that may be part or the whole of the data on the document. In the case of checks, the data that is embedded could be any selection of the variable data, as opposed to the check stock data. This variable data includes payee, amount, account number, date, bank routing number and data unique to a particular bank.

In the traditional printing of checks, the added data simply appears in text form and this will also be the case in the main implementation of this invention. Thus, the added data comprises a set of distinguishable characters. This data or a subset or digest of this data is added in a form that is machine readable and generally not human readable. The machine readable data is embedded in discrete segments so that if one segment is damaged the remainder may still be valid and able to give information about the likelihood of deliberate falsification. Conventional hashing or encryption based techniques cannot meaningfully assess the extent of a mismatch between human readable text and machine readable text and hence inevitably lead to large numbers of false positives.

The encoding of a given character that might appear in both the human readable text and the machine readable text is such that the chance of inaccurately interpreting the character when in the human readable data as a different character is inversely proportional to the chance of inaccurately interpreting the same character as the same different character when in the machine readable data. Hence, actual individual coding of these characters is such that their chance of confusion in the machine readable code is inversely proportional to their chance of confusion by the OCR methods. That is to say, one form of data embedding is a function of the retrieval probabilities of another form of data embedding.

An implementation of this invention deploys a function which predicts the probability of deliberate falsification, as opposed to misreading, by constructing the data retrieval process to return information about the nature of any errors. Thus the probability of deliberate falsification will be a function of the measured quality of the image, the machine readable code and the human readable data, measured by the fact that these entities give clear, unambiguous symbols or are difficult to resolve. The probability of deliberate falsification will also be a function of such parameters as the relative position/distribution of mismatches, e.g. of erroneously detected characters, having regard to the fact that falsification usually involves a coherent set of contiguous characters rather than randomly separated characters.

### BRIEF DESCRIPTION OF THE DRAWINGS

The invention will be described with reference to FIGS. 1(a) to (d), which show how a seal that graphically encodes data might appear when scanned and interpreted;

FIG. 2 which schematically depicts how the probability assessment of whether a mismatch is fraudulent or not varies depending on image quality and letter distribution.

### DETAILED IMPLEMENTATION

Workflow

Many large corporations print their own checks in a bulk processing environment using high speed printers, usually laser printers. The usual method is to have check stock preprinted with general information about the Bank to whom the check must ultimately be presented for encashment, its routing number and similar data which is common to thousands of checks. The individualised data required before issuance of the check includes payee name, account number, date, amount of transaction etc. and this is usually added by a laser printer.

In the present invention, a ‘seal’ or other machine readable code is printed at the same time as the individualised variable data is added. This is generally achieved by adding an image of the seal to the printing file before it is despatched to the printer, but it can be equally well achieved by modifying the PCL commands or the use of soft fonts if they are the means that will best accord with the running of the system. PCT/GB02/00539 may be referenced for further details about ‘Seal’ encoding.

In the normal cycle of the check, the payee pays in the check to the “Bank of First Deposit” or to a check cashing outlet. At this point the human readable data is read and possibly a cash payment takes place. In one implementation of this invention, the seal containing authenticating data will also be read using a simple desk top scanner or equivalent check reader.

The check is then forwarded to the issuing Bank or financial services company acting for the Bank High speed scanners are used to capture images of both the front and back of the check in a bulk processing mode with minimal human intervention. The analysis of data and reconciliation of the checks then takes place using the images. In accordance with this invention, the data on any seals will be read and analysed either at this point or as part of an offline process. At this point also, any checks which do not meet acceptance criteria, perhaps on account of being damaged or unreadable or because two forms of data do not match, will be identified as exceptions and be subjected to further examination.

Data for Machine Readable Code

The variable data that is printed on the checks just prior to issuance includes the payee name, the amount, the account number, the date. The amount and account number are also included in the MICR line printed at the bottom of the check and which provides another machine readable source of data

In the proposed implementations, a seal containing at least two of these entities in machine readable form will be printed onto the check. We encode algebraically human readable data from the check, where the data is in the form of characters from a known alphabet, convert the algebraic information into a graphical form, and then print the graphical form onto the check at the same time as the human readable data is printed. The form of coding of the machine readable graphic is dependent upon the characteristics and retrievability of the human readable form.

The data is in the form of alphanumeric characters which are converted to binary strings before being represented in graphical form. An important feature of the conversion to binary format is the fact that each string consists of independent but interleaved segments, each segment representing a character or small group of characters. Thus if 10 letters were to be converted to a binary string, each letter might be represented by 16 bits and these bits might be interspersed in a string of 160 bits according to some rule. If one of the letters were to be changed only the 16 corresponding bits would be changed and there would be no knock on effect on the rest. Similarly, if 1 bit were to be changed only one of the letters would be affected.

The manner of representation of characters in binary form is a key part of this implementation. In many applications, the codes representing characters are generated using an established error coding technique. Often used are cyclic codes on account of their structure which lends itself to easy decoding. In the case of this invention, there is no need for highly structured codes because the chunks of data to be decoded are small enough to be handled by cruder methods. The main requirement is that the “Hamming Distances” (HD) between codes should be chosen so as to best reflect the quality of information derivable from the scanned images.

The HD between two codes of equal bit length is simply the number of bit positions in which the codes differ. Thus if 2 codes have a large HD they are unlikely to be confused unless there is a large number of bit errors. The penalty for making HD's too large is that the codes become too long and occupy too much of the available payload. The HD between binary representations of a pair of characters will be greatest for those pairs which are least likely to be easily differentiated by an OCR method.

The factors affecting the HDs are, according to this invention:

(a) The quality of the images of the seals.

In most implementations there will be many checks available to standardise data and find expected values for any quality measurements. The quality of the images is a function of the resolution of the scanners, their quality in terms of tendency to merge distinct features or produce artefacts and any issues arising from the rapid transport of checks through the processing system. The quality is also a function of the consistency of the printing method and such matters as level of toner within a printer. This quality has to determine the overall distribution of HD's of any set of codes, ensuring that the likelihood of a misread is at a satisfactory level. Thus if image quality is very poor the number of bits in the codes will be increased to allow a greater error margin.
   (b) The accuracy of any OCR reader
The number of errors produced by the OCR reader should give an additional guide to the accuracy required of a Seal and hence the overall distribution of HDs.
In addition HDs should be adjusted to take into account the fact that some characters are far more likely to be confused by OCR than others. “O” for instance is frequently mistaken for “C” but “Z” is rarely mistaken for “I”. To cope with this property of OCR the HD's between the code for “O” and code for “C” will tend to be larger than between those for “Z” and “I.” Thus although the OCR may tend to confuse “O” and “C”, the Seal reading would be highly unlikely to do so.

With these considerations in mind a set of codes can be generated to represent the characters and hence convert the human readable text into a binary string.

Representation of Data in Machine Readable Form

In a preferred embodiment the form in which the data is added is that described in detail in the Bitmorph patent PCT/GB02/00539.

In an alternative embodiment, the data is added in the form of a two dimensional bar code.

Analysis of Seal

The scanners provide images of checks, generally in black white, for the purposes of analysis. A further source of data may be from the reading of the MICR line by a device which reads magnetic ink.

Where there is machine readable code such as that produced by bar codes, glyphs or Seals there are many well described techniques to orientate and scale images prior to analysis of individual code bearing symbols. For the purposes of this description it will be assumed that the analysis can be taken to the level where the information is contained in a set of graphics, each graphic being a cell containing a configuration of black and white pixels which is to be interpreted.

Thus where glyphs are used the cells will typically be squares containing black pixels which in the original image formed a diagonal stripe, the orientation of the stripe indicating whether the symbol is to be counted as a “1” or a “0.” This configuration will be modified by the printing and scanning processes so that what was originally a sharp clear line will become a more irregular feature. The task of the decoder is to interpret whether such a feature was meant to be a forward or backward sloping diagonal.

Similarly if a seal is used, the cells will be of a variety of shapes and will contain configurations that may originally be vertical or horizontal lines but in the scanned images will appear as more diffuse shapes.

In two dimensional bar codes, the cells will typically be rectangles each containing 4 black rectangular segments and 4 white spaces in the original form, but after scanning will contain irregularities.

It is one of the purposes of this invention to assess any of these forms of machine readable code for the level of image quality degradation and provide a representative quality statistic. By empirically analysing the distribution of this statistic for a large number of checks and associating the quality statistic with the number of errors that is produced in the corresponding decoding process, a prediction of likely errors/artefacts for a given image with measured quality parameters may be produced. In this way, one can assess the probability of mismatch between human readable and machine readable data arising through printer or scanner errors/artefacts and not deliberate falsification.

For glyphs and seals, a set of graphics will correspond to a binary string representing a single character. For instance, each of 40 characters may be represented by 16 bits with HDs chosen appropriately, in other words 16 graphics go to make up a single character. The analysis will allocate to each graphic a “1” or “0” to correspond to the binary string. In many cases there will be several of the bits interpreted wrongly. If the number of errors is within the bounds that the error correction can rectify, the character that is allocated will be that whose binary string has the smallest HD from the interpreted graphics.

In some implementations instead of allocating one of two possible values to a graphic, a range of values will be allocated. A number 100 might indicate, for example, a perfect vertical stripe, whilst —100 might indicate a perfect horizontal stripe. A value of +50 would correspond to a vertical stripe with some extra artefacts. FIG. 1 shows a set of graphics before and after scanning with a set of values allocated according to the closeness to a vertical or horizontal stripe.

Calculation of HD is modified thus. A binary code such as 1110 0011 1100 1110 is allocated 16 values by replacing each “1” by “100” and replacing each “0” by −100.

Thus the code becomes

{100, 100, 100, −100, −100, −100, 100, 100, 100, 100,−100, −100, 100, 100, 100, −100}

The set of scanned graphics corresponding to a character might become, for example, {80, 70, 70, −20, −30, −50, −10, −20, 70, 90, −90, −50 50, 60, 50.0 }

The HD of this set of 16 graphics from the code would be the sum of the differences for each of the 16 components. That is: HD between the scanned code and the tested character

=20+30+30+80+70+50+110+120+30+10+10+50+50+40+50+100=850.

The same calculation would be carried out for each of the codes and the code with the smallest HD would be presumed to correspond to the original machine readable data.

Each set of graphics will be tested against the chosen vocabulary or alphabet of characters. In each case there will be an adjustment (corresponding to the value 850 above) needed to match a given scanned code to one of the vocabulary codes. The sum of the adjustments gives another metric for comparing the quality of the scanned image.

The calculation just described is a non-limiting example of a further aspect of the invention. The decoding of the seal gives a most probable set of values for the characters. In addition the decoding of the seal allows the allocation of probabilities to one character rather than another. Thus, if for a set of 16 graphics the HD from the letter “A” were to be 800 and the HD from the letter “B” were to be 850 there would be quite a high probability that if an “A” appeared where a “B” was expected then this was due to reading error rather than deliberate falsification.

Optical Character Recognition (OCR)

The variable data, in particular the payee name and the amount are read automatically from the scanned images by one of the many available OCR software applications.

In a preferred implementation of this invention, the OCR application reads the human readable characters on the check and attributes a probability to some or all of the characters in the selected alphabet or vocabulary. In general, the probabilities are only relevant for two or three characters whose shape most nearly approximates the scanned in figure.

In another implementation, the characters that are read from the Seal are passed to the OCR application. The application then considers each supposed character and attributes a probability to the hypothesis that the character read by the OCR is indeed the one proposed by the Seal. This process of verification may thus accept as correct a letter that a normal OCR process might reject; OCR might suggest an ‘E’ where this form of verification might accept that the real character was an ‘F’ corrupted by the presence of a horizontal line produced by the rapid movement of the cheque across the scanner.

Combining OCR Data and Seal Data

From the foregoing it can be seen that after the Seal reading and the OCR there will be two sets of data which must be compared to authenticate the check in question.

If the OCR data is identical to the Seal data then the check is accepted as authentic. If one or more characters differ then an assessment has to be made as to the cause and the recommended action.

In one implementation the assessment might be as follows.

First, a measure is taken of the degree of difference between the OCR data and the Seal data. This might be measured by a metric such as the Levenstein distance which takes into account characters that are substituted, omitted or inserted, or, more appropriately by a metric that is specially tailored to match the known attributes of the system (e.g. printer attributes and performance; scanner attributes and performance; image quality; operator assigned rules etc). The metric will include recognition of the close similarity between certain pairs of characters. Thus if a Z appeared where an I were expected a distance of 1.0 might be ascribed, but if a O appeared in place of an 0 a distance of 0.2 might be ascribed.

This metric also takes into account the possible misreads in the Seal where probabilities can be attached through knowledge of the HDs between characters.

Modification of the measured distance can result from assessment of the significance of the positions in the text in which differences occur. If, for instance, three unmatched characters were randomly distributed through the payee text then it is less likely to be the result of deliberate falsification.

Analysis of the image can be carried out to identify artefacts that have been produced by the scanning process. Such artefacts are often easily recognised as arising from the movement of the check. A further quality factor is the darkness of the image which depends both on the amount of toner added at the time of printing and the threshold value of the scanner.

The extent to which the quality factors affect the Seal and OCR is assessed empirically by sampling large numbers of checks. This sampling will provide an ongoing standardisation.

The overall result is a metric for the difference between Seal and OCR data that is dependent on environmental factors, methods selected for coding and means of interpreting code in graphic form.

In one implementation the MICR information on the check is read and compared with the supposedly identical information in the Seal. The accuracy or otherwise of this comparison is an indicator of the quality of the Seal data, particularly because the MICR information is read to a high degree of accuracy.

Once the difference between Seal data and OCR data has been calculated a threshold has to be decided upon so that checks on one side of the threshold are further examined to see if they might be counterfeit. The level of the threshold depends upon the penalties for false positives and the known likelihood of counterfeits.

The following is a non limiting example of how the invention might figure in an image enables cheque environment typical of the situation arising from implementation of the Check 21 Act. Images are scanned at sorters in a central clearing operation.

In a preoperational pilot scheme, a set of typical cheque images with known text is collected for analysis. The cheques will have been subjected to the typical degradation that might occur to genuine circulated cheques. An OCR engine is used to read various types of the known text data including Payee Name, Amount and Courtesy Amount. The number and type of reading errors are assessed as a function of
(a) image quality as measured by heaviness or lightness of image (usually a function of scanners rather than printers,) contrast levels if greyscale, presence of streaks (typical artefacts of high speed scanning), accuracy of orientation.
(b) type of font, for instance, a lower case serif font at no more than 10 point will have a higher error likelihood than a non serif font in upper case.
(c) particular characteristics of printing quality from specific accounts.

Another set of cheques is printed with machine readable symbols of the type to be used, unencoded but with known values. Again these cheques are degraded in a typical fashion and scanned on standard cheque sorters, the images being used for analysis. The probability of misread is measured, again as a function of image quality.

A set of cheques with some degree of error is presented to human operators whose task it is to decide whether the error would be regarded as a likely indicator of fraudulent falsification or as an insignificant typographic change. From this will be derived an algorithm that attaches probabilities to various types of discrepancy. Perhaps, for instance, one or two isolated letters changed may be regarded as likely typographic errors, whereas a group of incorrect adjacent letters would be a cause for further inspection. The decisions will be based on the knowledge of the types of falsification that characterise deliberate fraud.

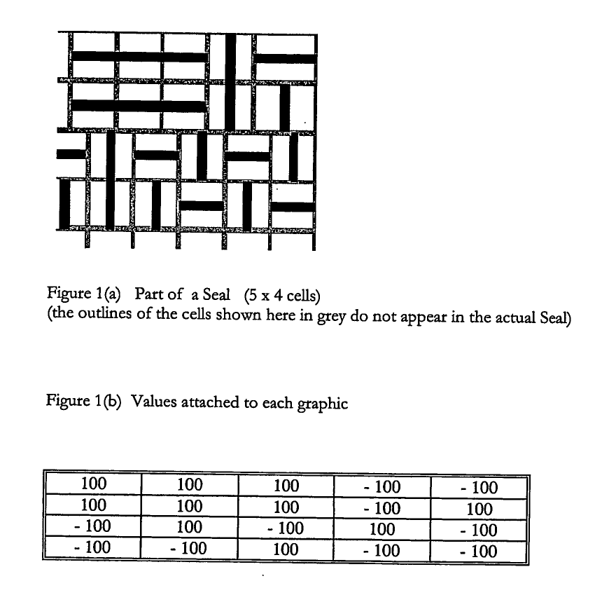

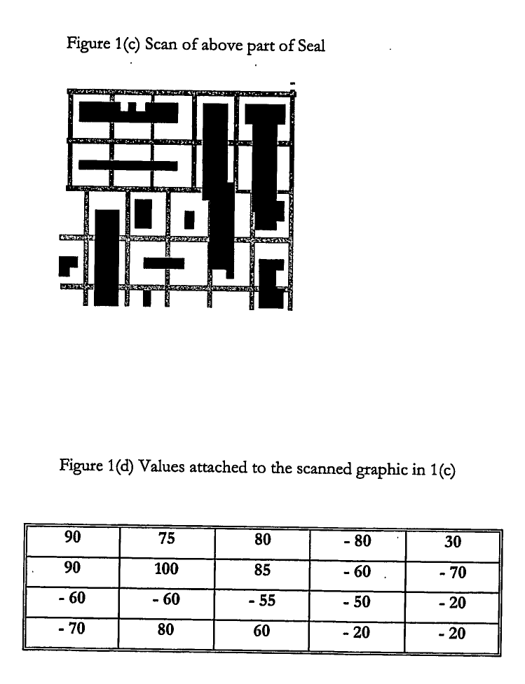

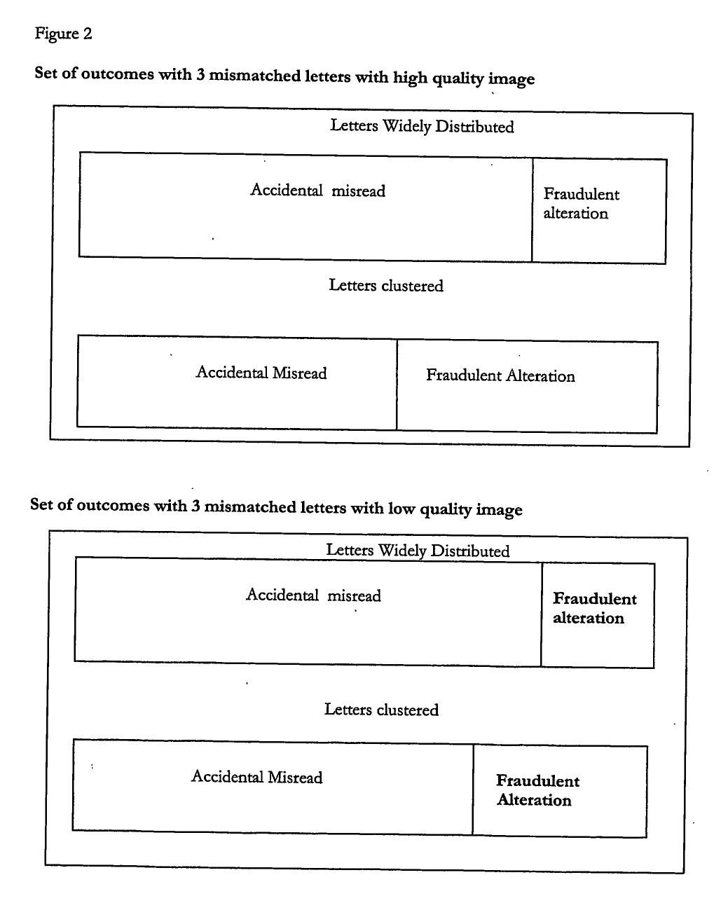

From these pilot investigations a verification scheme will be constructed. The encoding for the machine readable code will include a level of error correction that will achieve a selected threshold of error, maybe 99.5%. The payload on a check is limited, particularly by the resolution of the scanners and so error correction must have a finite limit. The probability of occurrence of fraud is a known distribution and an algorithm exists which combined with the above probabilities provides a rule for selecting likely exceptions. The probability is assessed with reference to the distribution of errors within the text. This is illustrated in FIG. 2, which shows how the relative probability of an accidental misread as compared to fraudulent alteration varies depending on image quality and also letter distribution. For, the likelihood of an accidental misread has to be set higher for a low quality image as compared to a high quality image. At a given quality, clustering of mismatched letters leads to a higher likelihood of fraudulent alteration.

When the cheques with the agreed machine coding are issued and subsequently returned to the clearing sorters, the images produced are analysed. If the text and machine readable code are read as agreeing, then the cheque is accepted. If there is a mismatch then analysis based on the above probability functions takes place as below.

First, the image quality is measured. If the human readable data is read as textH and the machine readable quality is read as textM, the probability that textH is a misread of textM is calculated using the probability as a function of image quality and the other factors cited above. If, for instance, in a poor quality image an ‘O’ is read as a ‘C’ the probability of this being accidental is high. The probability that textM is a misread of textH is then considered, again using the probability as a function of image quality and the level of difference between the coded forms of textH and textM. The combined probabilities give the probability of accidental error. This probability is then compared with the rules deduced from the human operators where the probability of a particular type of error is assessed as a likely indicator of fraudulent alteration.

The probabilities in this scheme are continually updated by accumulation of information about image quality and levels of fraud.

1. A method of automatically verifying the authenticity of a printed document which includes printed human readable data and corresponding machine readable data, the method comprising the steps of:
(a) scanning the document to generate a scanned image;
(b) interpreting the individual characters printed as human readable data and interpreting the individual characters printed as machine readable data;
(c) assessing the probability that any mismatch between the individual characters interpreted from the human readable data and the machine readable data has arisen through errors or artefacts introduced in printing or scanning the document and not deliberate falsification of the human readable data.

2. The method of claim 1 in which individual characters are encoded in the machine readable data.

3. The method of claim 2 in which the form of encoding deployed for the machine readable data is a function of the encoding used to construct the human readable data.

4. The method of claim 3 in which the encoding of a given character that might appear in both the human readable text and the machine readable text is such that the chance of inaccurately interpreting the character when in the human readable data as a different character is inversely proportional to the chance of inaccurately interpreting the same character as the same different character when in the machine readable data.

5. The method of claim 1 in which the assessed probability of mismatch arising through printer or scanner error or artefact is a function of the quality of the scanned image.

6. The method of claim 5 in which the assessed probability is increased as image quality decreases.

7. The method of claim 5 in which image quality is measured as a function of one or more of: the lightness or darkness of the image; the contrast of the image; whether features of known shape in the document appear in a similar shape in the scanned image; the degree of adjustment required to make mismatched characters match; mismatch from MICR data; orientation accuracy of the scanned image.

8. The method of claim 5 in which the assessed probability is a function of the relative position or distribution of any mismatches such that clustered mismatches decrease the probability that the mismatches arise through printer or scanner error or artefact.

9. The method of claim 1 in which the assessed probability is a function of the font used for the machine readable data.

10. The method of claim 5 in which the assessed probability is a function of rules specified by a human operator or empirically derived by analysing extensive manual assessments made by skilled operators of different kinds of mismatches.

11. The method of claim 1 comprising the steps of:
(a) establishing a first probability based interpretation of the human readable text;
(b) establishing a second probability based interpretation of the machine readable text;
(c) assessing the probability by comparing the probability based interpretations.

12. The method of claim 11 in which the first probability based interpretation and the second probability based interpretation uses a metric specifically tailored to one or more of: printer performance; scanner performance; image quality; operator assigned rules.

13. The method of claim 12 in which the assessment of the probability uses a metric specifically tailored to one or more of: printer performance; scanner performance; image quality; operator assigned rules.

14. The method of claim 1 in which the document is not submitted to further scrutiny if the assessment of probability is above a predefined threshold.

15. The method of claim 1 in which the document is submitted to further scrutiny if the assessment of probability is below a predefined threshold.

16. The method of claim 15 in which the threshold can be varied by an operator depending on one or more of printer performance; scanner performance; image quality; operator assigned rules.

17. The method of claim 1 comprising the steps of:
(a) Encoding algebraically human readable data from a check, where the data is in the form of characters from a known alphabet, converting the algebraic information into a machine readable graphical form, printing the graphical form onto the check at the same time as the human readable data is printed;
(b) Scanning the said check;
(c) Reading the human readable data using an OCR scheme which allocates probabilities of each member of the alphabet corresponding to any feature identified as a character;
(d) Reading the machine readable data and allocating probabilities of each member of the alphabet corresponding to any feature identified as a character in the machine readable data;
(e) Comparing the resulting sets of probabilities and establishing an overall probability that any mismatch is due to reading error rather than deliberate falsification.

18. The method of claim 17 where the form of coding of the machine readable graphical is dependent upon the characteristics and retrievability of the human readable data.

19. The method of claim 18 where the Hamming distance between binary representations of a pair of characters will be greatest for those pairs which are least likely to be easily differentiated by an OCR method.

20. The method of claim 17 where the machine readable data consists of independent segments that enable recovery of partial information when there is localised degradation.

21. The method of claim 17 where the analysis of the machine readable data provides a measure of the degradation of the image of the check and this measure in turn and assists in the attribution of probabilities to the likelihood of a mismatch arising through printer or scanner errors or artefacts and not deliberate falsification.

22. The method of claim 17 where the degradation of the human readable data is assessed by image processing methods and assists in the attribution of probabilities to the likelihood of a mismatch arising through printer or scanner errors or artefacts and not deliberate falsification.

23. The method of claim 17 where the probability of occurrence of fraud is a known distribution and an algorithm exists which combined with the above probabilities provides a rule for selecting likely exceptions.

24. The method of claim 23 where the probability is assessed with reference to the distribution of errors within the text.

25. The method of claim 17 where the set of elements that make up a character in the representation in graphical form are distributed throughout that form so as to survive moderate localised degradation.

26. A document that has been subject to automatic verification using the method as defined in preceding claim 1.

27. The document of claim 26, which is a check.
